(19) United States
(12) Patent Application Publication
(10) Pub. No.: US 2016/0210396 A1
(43) Pub. Date: Jul. 21, 2016

(54) METHOD AND APPARATUS FOR VISUALIZING TIMING MARGIN ON A GRAPHICAL USER INTERFACE

(71) Applicant: Avago Technologies General IP (Singapore) Pte. Ltd., Singapore (SG)

(72) Inventor: Jason Todd Gentry, Windsor, CO (US)

(21) Appl. No.: 14/602,265

(22) Filed: Jan. 21, 2015

(51) Int. Cl. G06F 17/50

(52) U.S. Cl. CPC G06F 17/5081

(57) ABSTRACT

A system and method are provided that enable the analysis of the timing slack for block-to-block connections. Based on the analysis of the timing slack for block-to-block connections, timing path slack values are determined and used to render a presentation of the timing path slack values along with a presentation of the block-to-block connections in a rendering of a circuit design.

### FIELD OF THE DISCLOSURE

The present disclosure is generally directed toward Integrated Circuits and methods of designing the same.

### BACKGROUND

The process of building an Integrated Circuit (IC) or integrated circuit chip typically involves physical implementation followed by verification. Part of this verification process involves static timing analysis. Often times, design changes require that blocks (e.g., components or groupings of components on the integrated circuit) be moved around to address gate growth or to address other floorplan needs. Unfortunately, these changes often have a negative impact on static timing closure. Because timing reports are textual, there is no easy way to see how far blocks can be moved before seeing a negative impact on timing without detailed analysis of the timing reports. This results in significant engineering attention which, in turn, results in wasted machine and license resource use and schedule delay.

### BRIEF DESCRIPTION OF THE DRAWINGS

The present disclosure is described in conjunction with the appended figures, which are not necessarily drawn to scale:

FIG. 1 is a block diagram depicting a communication system in accordance with embodiments of the present disclosure;

FIG. 2 is a block diagram depicting details of a computing device and/or server in accordance with embodiments of the present disclosure;

FIG. 3A is a block diagram depicting an illustrative integrated circuit layout in accordance with embodiments of the present disclosure;

FIG. 3B is a first detailed view of blocks and block-to-block connections in the integrated circuit layout of FIG. 3A;

FIG. 3C is a second detailed view of blocks and block-to-block connections in the integrated circuit layout of FIG. 3A;

FIG. 3D is a third detailed view of blocks and block-to-block connections in the integrated circuit layout of FIG. 3A;

FIG. 3E is a fourth detailed view of blocks and block-to-block connections in the integrated circuit layout of FIG. 3A;

FIG. 3F is a fifth detailed view of blocks and block-to-block connections in the integrated circuit layout of FIG. 3A;

FIG. 4 is a flow diagram depicting a method of visualizing timing margin of block-to-block connections for an integrated circuit design in accordance with embodiments of the present disclosure;

FIG. 5 is a flow diagram depicting a method of responding to a query for detailed connection information in accordance with embodiments of the present disclosure; and

FIG. 6 is a flow diagram depicting a method of automatically updating a display of connection information in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

While embodiments of the present disclosure will be described in connection with the design of integrated circuits and integrated circuit chips, it should be appreciate that embodiments of the present disclosure can be applied to any design process where modification of one variable (e.g., physical position of an element or component in a system) impacts another variable (e.g., communication delays between components of the system).

Integrated circuits consist of a large number of electronic components that are fabricated by layering several different materials on a silicon base or wafer. The physical design of an integrated circuit transforms a circuit description into a geometric description which is known as a layout. A layout consists of a set of planar geometric shapes in several layers.

The objective of physical design is to determine an optimal arrangement of devices in a plane or in a three dimensional space, and an efficient interconnection or routing scheme between the devices to obtain the desired functionality. Since space on a wafer is very expensive real estate, algorithms must use the space efficiently to lower costs and improve yield.

The input to the physical design problem is a circuit diagram, and the output is the layout of the circuit. The physical design is accomplished in several stages including partitioning, floor-planning, placement, and routing.

A chip may contain several million transistors. Layout of the entire circuit cannot typically be handled by currently available floor-planning tools due to the limitation of memory space as well as the computational power available. Therefore, the circuit is normally partitioned by grouping the components into functional blocks such as subcircuits and modules. The actual partitioning process considers many factors such as the size of the blocks, number of blocks and number of interconnections between the blocks.

The output of partitioning is a set of blocks, along with the interconnections required within and between blocks. The set of interconnections required is referred to as a netlist. In large circuits, the partitioning process is often hierarchical, although non-hierarchical (e.g. flat) processes can be used, and at the topmost level a circuit typically has between 5 to 25 blocks. However, greater numbers of blocks are possible and contemplated. Each block is then partitioned recursively into smaller blocks or sub-blocks.

The floor-planning step is concerned with selecting good layout alternatives for each block of the entire chip, as well as between blocks and to the edges. Floor-planning is an important step as it sets up the ground work for a good layout. However it is computationally quite hard. Very often the task of floorplan layout is done by a design engineer using a CAD tool. This is necessary as the major components of an integrated circuit are often intended for specific locations on the integrated circuit.

During placement, the blocks and locations of the block terminals, referred to hereinafter as block “pins”, within the blocks are exactly positioned on the chip. The goal of placement is to find a minimum area arrangement for the blocks that allows completion of interconnections defined by the netlist. Placement is typically done in two phases. In the first phase, an initial placement is created. In the second phase, the initial placement is evaluated and iterative improvements are made until the layout has minimum area and conforms to design specifications.

It is one aspect of the present disclosure to provide an integrated circuit designer with a method of displaying the timing margin available between blocks during the verification or design phase of an integrated circuit. Specifically, the visualization of timing margin during verification enables a designer to quickly identify changes in timing of the integrated circuit when a block is physically moved on the layout. As used herein, the term “block” refers to a grouping of digital circuit components on an integrated circuit that perform a particular function for the integrated circuit.

This allows the designer to quickly see which paths have minimal margin and which have margin to spare (e.g., communication delays are less than communication delay requirements). The analysis is much faster than sifting through the detailed timing reports looking for specific block-to-block paths.

In accordance with at least some embodiments of the present disclosure, a floor planning tool is provided as executable programming code (e.g., software, firmware, hardware, combinations thereof) on a client device and/or a server. The floor planning tool is configured to first read in a summary of the worst timing path slack per sequential input pin (e.g., top-level registers, top-level blocks, etc.). This information is then associated with the top-level block-to-block connectivity in an integrated circuit floorplanning tool. A flyline is then drawn from the launch instance (e.g., hierarchical stdcell block or top-level register) to the capturing instance (e.g., hierarchical stdcell block or top-level register). The worst-case slack for each block-to-block bus is used to determine what color to draw for the bus. The colors are chosen based on the slack tiers as defined by the user, a system administrator, or the like. For instance, white might be used to indicate less than 0 ps of margin (e.g., failing timing), red might be used to indicate timing margin from 0 ps to 300 ps (e.g., near-failing timing), yellow might be used to indicate timing margin from 300 ps to 500 ps, and green might be used to indicate timing margin above 500 ps.

These slack tiers can be adjusted based on the specifics of the integrated circuit design and other design considerations. The end result is a graphical visualization of the timing margin that exists between the blocks of interest. Furthermore, each flyline can be queried by the user to see what the slack is for the flyline and what pin the depicted slack is associated with.

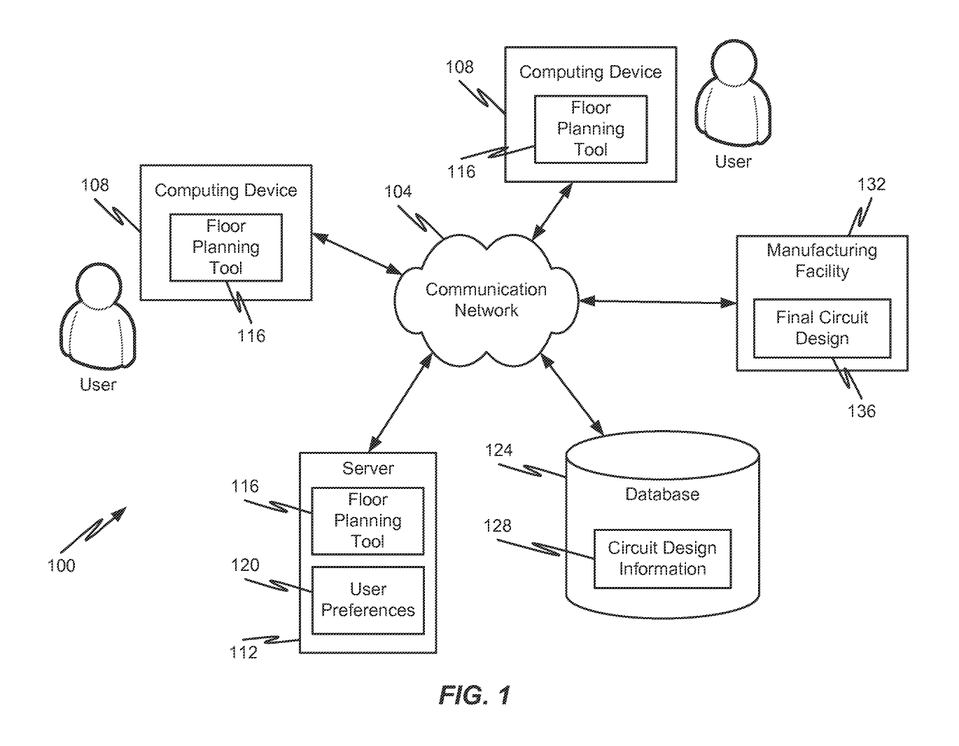

Referring now to FIG. 1, a system 100 for assisting with the design and configuration of integrated circuits and similar systems will be described in accordance with at least some embodiments of the present disclosure. The system 100 may include a communication network 104, one or more computing devices 108, one or more servers 112, and one or more databases 124. The communication network 104 may further provide communication capabilities between the computing devices 108 and/or servers 112 and a manufacturing facility 132.

The communication network 104 may correspond to any type of well-known computing or network environment (e.g., interconnection of two or more computing or communication devices). The communication network 104 may facilitate communications between all devices connected therewith using any type of known communication protocol. In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, an enterprise network, a contact center, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, a computing device(s) 108 may include a personal communication device, a dedicated computing device, or a combined communication/computational device. Examples of suitable computing devices 108 include, without limitation, a Personal Computer (PC), a tablet, a laptop, a Personal Digital Assistant, a thin client, a smartphone, or the like. The computing device 108 may be configured for operation by one or more users and may include local software and drivers that enable the user to utilize the processing and/or memory components of the computing device 108. Thus, the computing device 108 may include one or more user interface components including user inputs, user outputs, and combined user input/output devices.

The server 112 may include any type of dedicated processing component that is accessible to one or a plurality of computing devices 108 (e.g., client devices). The server 112 may store one or more instances of executable instructions thereon and the computing devices 108 may request the server 112 to execute some or all of those instructions on behalf of the computing device 108. Results of such computations can be provided to the computing device 108 via the communication network 104, which can then be rendered for presentation to the user via a user interface of the computing device 108.

The database 124 may include one or multiple types of data storage technologies. The database 124 may further include a database interface that enables the computing devices 108 and/or server 112 to interact with the database 124, store information on the database 124, retrieve information from the database 124, modify information stored on the database 124, etc. Suitable non-limiting examples of databases 124 that may be used to circuit design information 128 and/or any other content that is useful in the process of designing integrated circuits and layouts for the same include a hierarchical database, a graph database, a relational database, a network database, an object-oriented database, or the like. The database interface for the database 124 may utilize a language or format that is operable to extract useful information from the database 124. Examples of languages that may be used by the database interface include, without limitation, SQL, noSQL, NewSQL, and/or any other type of Database Management System (DBMS) known in the art.

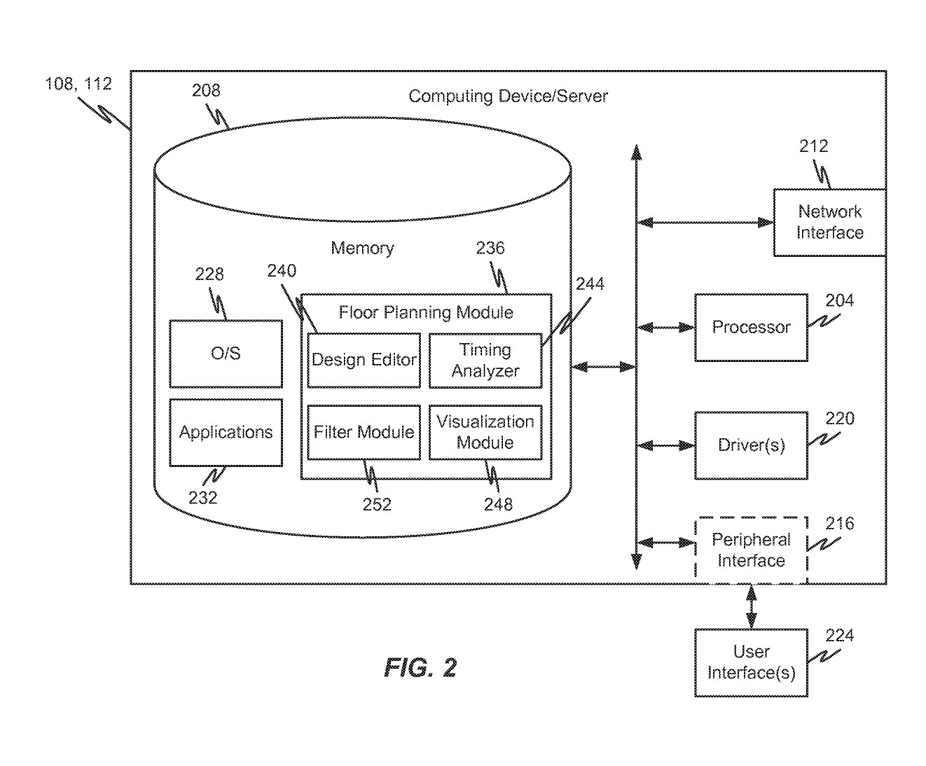

As shown in FIG. 1, a computing device 108 and/or server 116 may be provided with a floor planning tool 116. As will be discussed in further detail with respect to FIG. 2, the floor planning tool 116 may be stored as processor-executable instructions in memory of the computing device 108 and/or server 112. The floor planning tool 116, when executed, may enable a user of the computing device 108 to create, modify, and analyze floorplans or layouts for integrated circuits.

The floor planning tool 116 may include instructions programmed to perform the floor planning process(es) described herein. Typically, the floor planning process can be implemented as a set of procedures in Tool Command Language (TCL), which is a well known scripting language. The floor planning tool 116, in some embodiments, performs the floor planning and block partitioning processes in a known manner. As will be described in further detail herein, during these design iterations, the floor planning tool 116 may be configured to determining timing information for some or all block-to-block connections in the floor plan and present such information to the user in a way that facilitates a quick and efficient understanding of whether or not certain timing constraints or requirements for the integrated circuit can be met with the current layout or whether improvements to timing conditions have been made as a result of the layout change.

In particular, a user may be allowed to retrieve circuit design information 128 in the form of a netlist or the like that defines the blocks to be included in an integrated circuit design and the physical layout of such blocks and/or sub-blocks on the silicon of the integrated circuit. With the floor planning tool 116, the user of the computing device 108 may further be enabled to modify the floorplan and analyze timing constraints, among other things, for block-to-block connections and sub-block-to-sub-block connections. As the layout of the integrated circuit is changed, the floor planning tool 116 may enable the user of the computing device 108 to visualize, in real-time or near-real-time, changes to the timing margins for various block-to-block connections and how changes to block layout impact may improve or deteriorate timing performance of the integrated circuit. By enabling the user to see such impacts of layout modification in real-time or near-real-time, the user is allowed to more efficiently develop an optimal and workable integrated circuit design.

One advantage to using the server 112 to implement the floor planning tool 116 is that superior processing resources of the server 112 or a server cluster may be leveraged to execute what is often a processor-intensive application in the floor planning tool 116. In particular, the circuit design information 128 that is read and modified via the floor planning tool 116 is often on the order of Terabytes or more. Another advantage to using the server 112 is that user preferences 120 can be stored on the server 112, thereby enabling each user to have their visualization and presentation preferences accommodated even though shared resources of the server are being utilized by multiple users. The server 112 further facilitates efficient collaboration among users, thereby assisting in the team development of an optimal integrated circuit design. In some embodiments, the user preferences 120 may define each user's presentation preferences, each user's tool preferences, each user's input preferences, administrator preferences, sharing preferences, and the like.

As can be appreciated, the ultimate goal of using the floor planning tool 116 is to achieve a final circuit design 136. When such an integrated circuit design is finalized, the final version of the circuit design information 128 may be shared from the database 124 to a manufacturing facility 132 thereby enabling the production of one or more integrated circuits in accordance with the final circuit design 136.

With reference now to FIG. 2, additional details of a computing device 108 and/or server 112 will be described in accordance with at least some embodiments of the present disclosure. It should be appreciated that some or all of the components depicted in FIG. 2 can be entirely resident on a computing device 108, entirely resident on a server 112, split among a computing device 108 and server 112, or shared among a computing device 108 and server 112. The illustrated computing device 108 and/or server 112 is shown for explanation purposes only and is not intended to limit the location of any component thereof to a particular device in the system 100. To the contrary, the components depicted in FIG. 2 may be provided on one, some, or all of the devices in the system 100 without departing from the scope of the present disclosure.

The device 108/server 112 is shown to include a processor 204, memory 208, a network interface 212, an optional peripheral interface 216 (in the implementation of a computing device 108), and one or more drivers 220. The memory 208 may include any type or combination of known computer memory devices, whether volatile or non-volatile. Suitable non-limiting examples of memory 208 include Read Only Memory (ROM), Random Access Memory (RAM), Flash Memory, Buffer Memory, Electronically Programmable ROM (EPROM), Electronically Erasable Programmable ROM (EEPROM), magnetic memory, optical memory, quantum memory, variants thereof, or the like. In other words, the format of memory 208 may include any known or yet-to-be-developed memory format.

The instructions stored in memory 208 may be called, parsed, and executed by the processor 204. The process 204, in some embodiments, includes one or more processors. More specifically, the processor 204 may include one or more microprocessors that are capable of executing the instructions stored in memory 208. The processor 204 may also have internal memory that assists the processor 204 in executing instructions and performing various tasks. Although the contents of memory 208 are shown and primarily described as processor-executable instructions (e.g., software), it should be appreciated that the floor planning tool 116, the floor planning module 236, and other instructions shown to be stored in memory 208 may be partially or completely implemented in software, firmware, hardware, combinations thereof, or the like.

The network interface 212 provides the device 108/server 112 to connect with the communication network 104 and, therefore, interact with other computing devices 108 and servers 112 as well as other network-connected components (e.g., databases, other networks, etc.). The network interface 212, in some embodiments, may correspond to a wired network interface port or wireless interface (e.g., antenna and drivers). Some non-limiting examples of a wired network interface port correspond to an Ethernet port, a CAT-5 port, a CAT-6 port, or the like. Some non-limiting examples of a wireless network interface port corresponds to a Bluetooth® interface, a 802.11N interface (e.g., a WiFi interface), a cellular interface, an Infrared interface, or the like.

The peripheral interface 216 may be optionally provided in the implementation of a computing device 108, although a server 112 may also be equipped with one or more peripheral interfaces 116. The peripheral interface 216 provides an interconnection between components of the computing device 108 and external devices (e.g., peripherals). Peripheral devices most likely used in connection with embodiments of the present disclosure include one or more user interface 224 peripherals. The user interface(s) 224 may include user input devices (e.g., a mouse, pointer, keyboard, stylus, microphone, camera, etc.), user output devices (e.g., a printer, a speaker, a visual display such as an LCD or LED monitor, lights, buzzers, etc.), and/or combination user input/user output devices (e.g., touch-sensitive displays).

The driver(s) 220 may be configured for specific components of the device 108/server 112. As an example, each network interface 212 may have a corresponding driver 220, each peripheral interface 216 or specific peripheral device connected thereto may have a corresponding driver 220, and each user interface 224 may have a corresponding driver 220. The driver(s) 220 enable operation of the various components by control of the processor 204 when executing certain basic functions of the device 108/server 112.

As shown in FIG. 2, the memory 208 may include one or many different types of executable instruction sets. The illustrated examples of such instructions include an Operating System (O/S) 228, other applications 232, and a floor planning module 236. The floor planning module 236 may correspond identically to the floor planning tool 116 or to a component thereof.

The O/S 228 may correspond to a general-purpose application that enables a user of the device 108 to access other applications 232 and the floor planning tool 236. The O/S 228 may also include functionality that enables navigation of documents stored in memory 208 as well as an interface with database 124. Examples of suitable O/S 228 include, without limitation, Windows®, Linux, Mac O/S, Android®, IOS®, or the like. The O/S 228 may even be configured to include some or all functionality of the floor planning module 236 without departing from the scope of the present disclosure.

The other applications 232 may correspond to any type of known or yet-to-be-developed applications, applets, web-based applications, or the like. The applications 232 may include communication applications (e.g., phone applications, web browser applications, searching applications, email applications, text applications, etc.), integrated circuit design applications, collaboration applications, or the like.

The floor planning module 236 is shown to include a number of modules and components therein that help provide the functionality of the floor planning module 236. The illustrated components of the floor planning module 236 include a design editor 240, a timing analyzer 244, a filter module 252, and a visualization module 248. The design editor 240 may correspond to a portion of the floor planning module 236 that enables a user to view, create, add, modify, delete, or otherwise interact and edit integrated circuit layouts. The design editor 240 may provide editing tools and tools for presenting the current layout of an integrated circuit as well as tools for modifying locations or properties of blocks on the layout of the integrated circuit.

The timing analyzer 244 may provide the floor planning module 236 with the ability to analyze block-to-block and sub-block-to-sub-block connections on some or all of an integrated circuit layout. The timing analyzer 244 may perform such analysis in real-time (e.g., as changes are made to the layout with the design editor 240), in near-real-time (e.g., after changes are made to the layout but before committed to a circuit design iteration stored in the database 124), or after a layout has been saved to the database 124. As will be discussed in further detail herein, the timing analyzer 244 may be configured to determine timing information for blocks and block-to-block connections, association such timing information with the appropriate blocks and block-to-block connections, and present the timing information to a user in an easy to understand format. With the help of the visualization module 248, the presentation of timing information can be provided all at once or selectively, perhaps depending upon user preferences 120. In some embodiments, the visualization module 248 may help highlight certain blocks or block-to-block connections that have timing information associated therewith that may be of interest or concern to the user. The way in which such information is highlighted or presented to a user may include highlighting interesting blocks and/or connections, hiding of non-interesting blocks and/or connections, highlighting particular pins of blocks, preparing reports in an ordered fashion, or the like.

The filter module 252 may provide another mechanism for the user to view and refine views of an integrated circuit layout and, in particular, to query the entire layout for blocks or connections having certain properties (e.g., timing properties) associated therewith. The filter module 252 may also provide the ability to limit the amount of timing information presented to a user to only a subset of timing information that is deemed relevant and useful to the user at a particular time (e.g., as determined by a user's query for such information or as determined by the user's current utilization of the floor planning module 236).

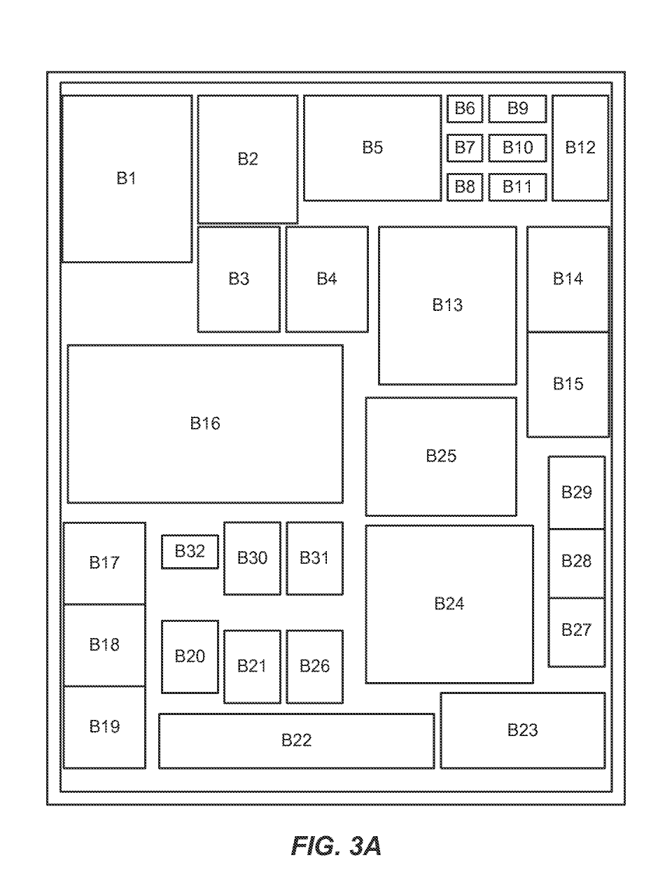

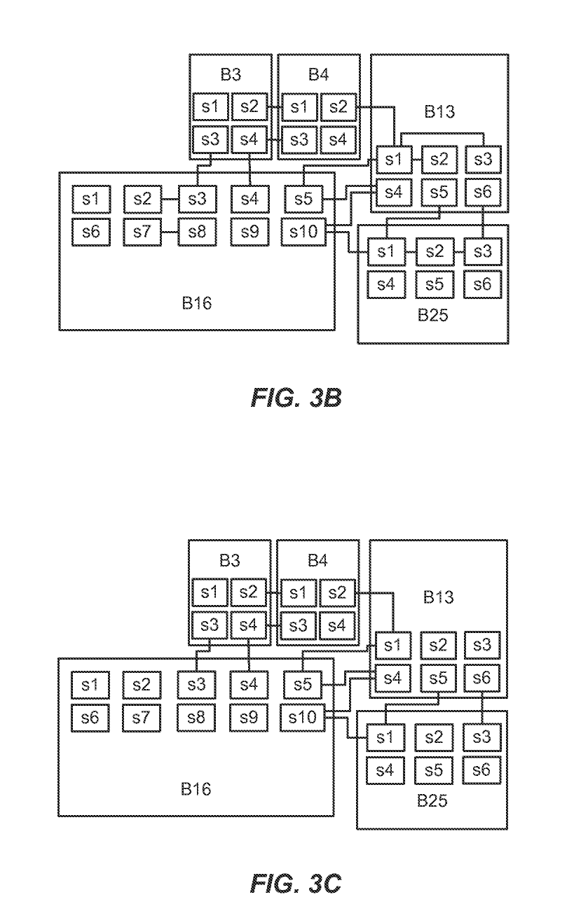

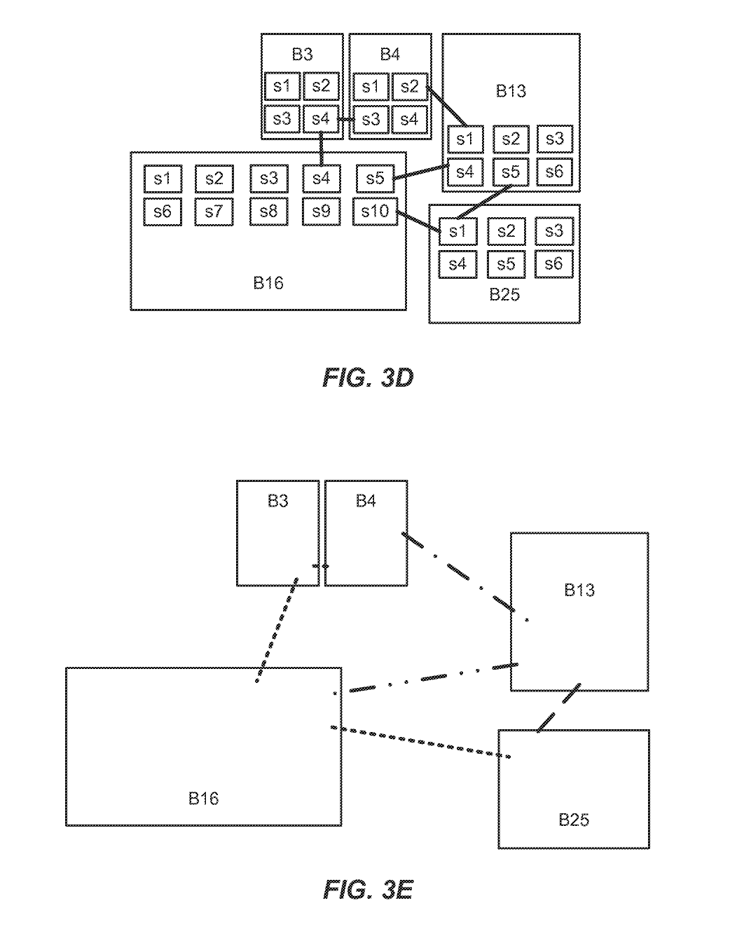

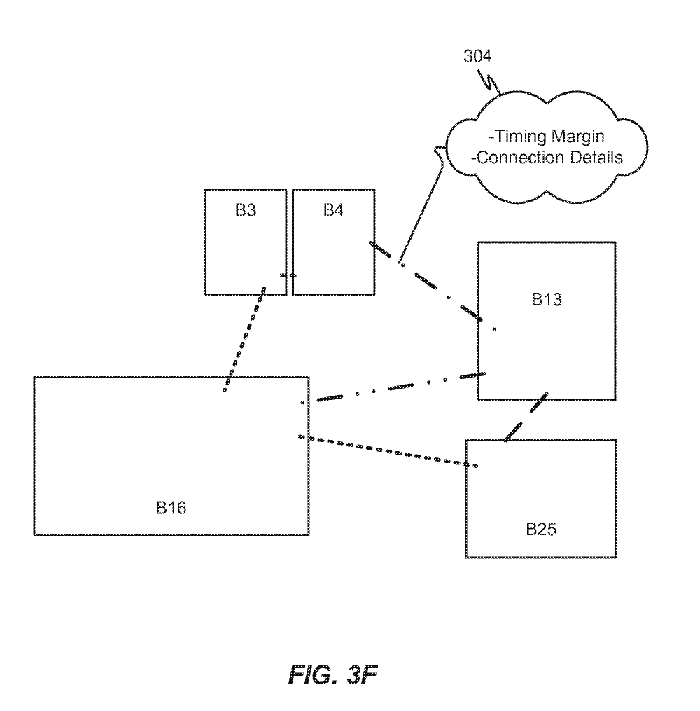

With reference now to FIGS. 3A-3F, further examples of a user's experience and interaction with the floor planning module 236 will be described in accordance with at least some embodiments of the present disclosure. The floorplan or integrated circuit layout depicted in FIG. 3A shows a plurality of blocks B1-B31 physically distributed in a non-overlapping fashion. Although a particular number of blocks B1-B31 are depicted, it should be appreciated that embodiments of the present disclosure may be utilized for an integrated circuit layout having any number of blocks greater than two, where the two or more blocks have at least one connection therebetween.

FIG. 3B shows a detailed view of a subset of blocks shown in FIG. 3A. In particular, blocks B3, B4, B13, B16, and B25 are shown for illustrative purposes. The blocks are shown to include one or more sub-blocks. As can be appreciated, blocks and sub-blocks may each have interconnections therebetween and even the sub-blocks may not correspond to the lowest-level of component on the integrated circuit layout. Instead, the sub-blocks may comprise or represent a plurality of digital processing components or circuits that are designed to perform a particular sub-routine within the larger block. Some blocks may have only two sub-blocks whereas other blocks may have a larger number of sub-blocks. The complexity of the function performed by a block may be associated with the number of sub-blocks contained therein, although a direct correlation is not required. In some embodiments a block may correspond to a top-level block or a top-level register in the integrated circuit layout. A top-level register may not necessarily have any sub-blocks whereas a top-level block may have two or more sub-blocks.

FIG. 3B also shows that because multiple sub-blocks from one block may be connected with multiple sub-blocks of another block, there may be more than one block-to-block connection between two blocks. For instance, block B16 is shown to have two block-to-block connections with block B3. In some embodiments, only one of the two or more block-to-block connections imposes the strictest timing constraint on the block-to-block connection between block B16 and block B3. In other words, if there are two or more connections between a pair of blocks, only one of the two or more connections may correspond to a connection that constrains timing for the pair of blocks.

Additionally, since a block may comprise two or more sub-blocks, there may be multiple intra-block connections (e.g., block-to-block connections between sub-blocks in a common block). For instance, block B 16 shows two intra-block connections between sub-blocks s2/s3 and s7/s8. These intra-block connections do not contribute to timing constraints on inter-block connections. Thus, as shown in FIG. 3C, as part of simplifying a display of connections for a user of the floor planning module 236, the visualization module 248 may remove, hide, or otherwise shift focus away from the intra-block connections. Instead, the block-to-block connections may be left as the primary blocks for visualization purposes and particularly with respect to timing constraints for block-to-block connections.

As shown in FIG. 3D, visualization of the integrated circuit layout may be further simplified to only depict the most constraining block-to-block connections in the layout. Other non-constraining connections may be hidden, deleted, or otherwise have focus shifted away therefrom to help the user of the floor planning module 236 to identify the most constraining connections for a pair of blocks in the integrated circuit layout. Moreover, as shown in FIG. 3D, the constraining connections may be displayed as flylines or some other indicator other than the physical connections between the blocks to further help ease the identification of the constraining block-to-block connections.

Further still, as shown in FIG. 3E, each block-to-block connection may be presented in accordance with a particular presentation format, which may depend upon timing information associated with the connection. For instance, a highly constrained connection may be depicted in one way whereas a connection that is violating timing margins or timing requirements may be depicted in a different way. As another example, a connection that is not highly constrained (e.g., has a timing margin greater than 500 ps) may be depicted in one color whereas another connection that is somewhat constrained (e.g., has a timing margin between 200 ps and 300 ps) is depicted in another color or line type. By presenting flylines in different ways based upon timing margin or other timing information associated therewith, the user of the floor planning module 236 is able to quickly identify whether certain blocks can be moved relative to other blocks in addition to determining whether certain changes to block layout negatively or positively impact timing performance of the overall integrated circuit.

As used herein, timing margin may be determined by determining an amount of time for a signal to travel from one block to another block along a block-to-block connection. That determined amount of time may be subtracted from a predetermined timing requirement or limitation to determine a timing margin. If the determined amount of time exceeds the predetermined timing requirement, then the timing margin is zero and the timing requirement is determined to be violated. As can be appreciated, a particular flyline presentation (color, type, weight, etc.) may be used to depict such block-to-block connections.

With reference to FIG. 3F, a user may be further enabled to query or select a particular flyline to determine timing information 304 associated therewith. In addition to or in lieu of depicting timing margin, the timing information 304 include average timing information for all connections between a pair of blocks, value corresponds to a worst timing path slack between blocks in the block-to-block connection, average timing path slack between blocks in the block-to-block connection, a maximum timing value, etc. Furthermore, a user may be enabled to use the filter module 252 to define timing information that is desired to be depicted and, in response to receiving such timing information, the connections meeting the search criteria may be displayed whereas other connections not meeting the search criteria may not be displayed or may be displayed in a differentiating way. Connection details may also be presented along with the timing information 304 to help the user further determine which pins are involved in the constraining connection and possibly help identify if a particular re-configuration of sub-blocks would help to alleviate any timing issues in the layout.

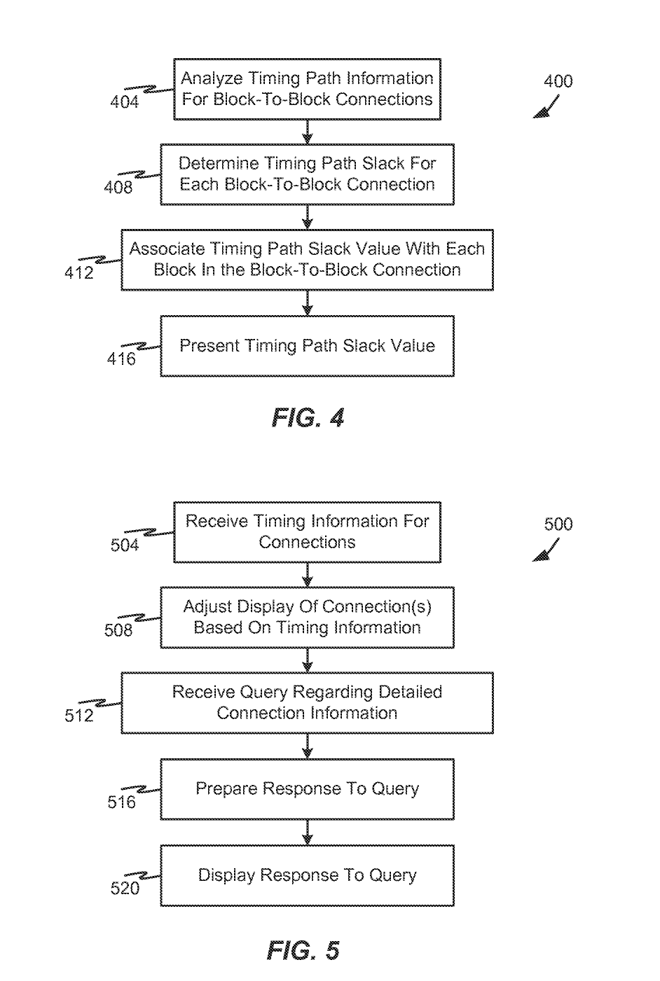

With reference now to FIG. 4, a method 400 of visualizing timing margin of block-to-block connections for an integrated circuit design will be described in accordance with at least some embodiments of the present disclosure. The method 400 begins with the timing analyzer 244 analyzing timing path information for block-to-block connections in an integrated circuit layout (step 404). In some embodiments, the timing analyzer 244 may analyze each and every block-to-block connection or a subset of block-to-block connections (e.g., corresponding to connections between selected blocks, corresponding to selected block-to-block connections, or corresponding to block-to-block connections that meet some user-defined criteria). It should be appreciated that while the term “block-to-block connections” may be interpreted as corresponding to connections between top-level blocks and top-level registers in the integrated circuit layout, the term “block-to-block connections” may also refer to connections between sub-blocks within a single block or within a plurality of blocks. The timing information that may be analyzed for a block-to-block connection includes determining a total timing threshold or maximum timing value associated with a connection, determining a timing path slack value (e.g., a difference between a maximum allowable signal delay and an actual or simulated timing delay between two blocks over a connection), determining a worst timing path slack value among a plurality of connections between common blocks (e.g., determining a ranking of timing path slack value among the plurality of connections and then determining which of the plurality of connections has the worst or no timing path slack value), determining maximum timing values associated with a connection, determining an average timing path slack between blocks, maximum timing margin (e.g., comparison between the worst case (minimum) slack versus the best case (maximum) slack among a plurality of connections between a pair of blocks), etc. Thus, as part of analyzing timing information for connections, the timing analyzer 244 may determine timing path slack for some or all block-to-block (or sub-block-to-sub-block) connections in the integrated circuit layout (step 408). Of course, the timing path slack may only be determined for a subset of all block-to-block (or sub-block-to-sub-block) connections.

Thereafter, the timing analyzer 244 associates the determined timing information and/or timing path slack values with each connection and/or each block involved in a connection (step 412). This timing information, timing path slack value information, and association information is then communicated to the visualization module 248, which prepares a presentation of the timing path slack value information, other timing information, or the like with the associated connection and/or block involved in the connection (step 416). In some embodiments, the visualization module 248 may simplify the display of the timing information and timing slack path values by only displaying the connections between a pair of blocks that have the worst timing path slack value among all connections between that pair of blocks. Thus, all other connections that are not limiting timing with respect to a pair of blocks may not be depicted, thereby enabling the user of the floor planning module 236 to easily identify the constraining connections and further determine when changes to block position negatively impact timing between the moved block and another block in the layout. Furthermore, the visualization module 248 may highlight or alter the type of display used for the constraining connections. For instance, if the most constraining connection has an acceptable amount of timing path slack, then the connection may be depicted as green whereas another connection that does not have an acceptable amount of timing path slack (or no timing path slack) may be depicted in red or bolded. Other presentation techniques can also be employed to facilitate the user's perception of timing information for connections between blocks or sub-blocks.

With reference now to FIG. 5, a method 500 of responding to a query for detailed connection information will be described in accordance with at least some embodiments of the present disclosure. The method 500 begins when timing information is received for one or many connections in an integrated circuit layout (step 504). The timing information may be received from existing circuit design information 128 or from modified circuit design information that has not yet been stored (e.g., a real-time modification of the circuit design has been made but the design has not be stored or otherwise saved in database 124). The display of some or all of the connections between blocks or sub-blocks (if such a presentation is made of sub-blocks) may then be adjusted based on the timing information or timing path slack values associated therewith. For instance, if a connection is not a constraining connection between two blocks with respect to timing slack for the two blocks, then that particular non-constraining connection may be deleted from the display, hidden from the display, or otherwise have its presentation minimized as compared to a constraining connection between the two blocks.

Thereafter, the user may provide the floor planning module 236 with a query to view detailed connection information (step 512). The query may be in the form of selecting a particular connection of flyline displayed to the user, selecting one or more blocks, selecting one or more sub-blocks, or entering search criteria into a search field. With respect to a detailed search query, the user may be allowed to indicate that he/she wants to view all connections having a timing path slack value less than a user-defined amount (e.g., less than 200 ps). Alternatively or additionally, the user may be allowed to indicate that he/she wants to view the five (or some other user-defined value) connections having the worst timing path slack values. Other restrictions on the search criteria may also be envisioned and the examples provided herein are not intended to limit the scope of the present disclosure.

Based on the query received from the user, the filter module 252 may determine which blocks or connection meet the query requirements and prepare a response to the query (step 516). Specifically, the filter module 252 may remove or minimize the display of connections that do not meet the query requirements. The filter module 252 may also display detailed connection information 304 about one or more connections or blocks that do meet the query requirements. This detailed connection information 304 can be presented to the user in any fashion.

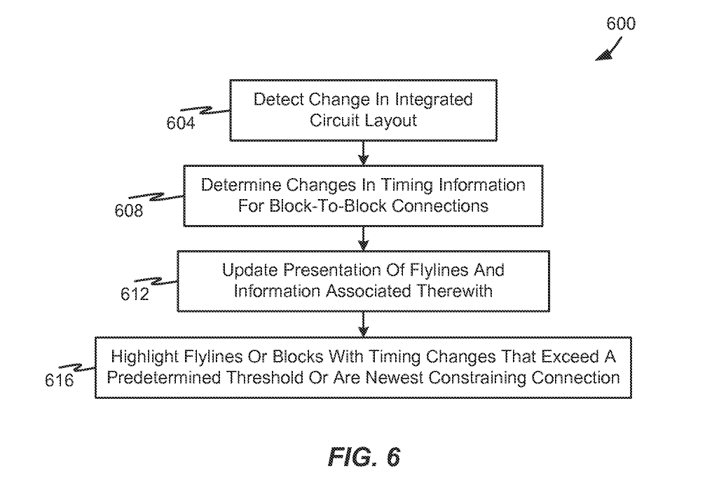

With reference now to FIG. 6, a method 600 of automatically updating a display of connection information will be described in accordance with embodiments of the present disclosure. The method 600 begins when a change in an integrated circuit layout is detected (step 604). This change may be detected immediately when a block is moved on the layout or after a block has moved and in response to receiving a command to save the new version of the layout. In response to detecting the change in layout, the timing analyzer 244 may determine changes to timing information for some or all of the block-to-block connections in the layout (step 608). In some embodiments, this analysis could be limited to those connections between blocks that have been moved in step 604. Alternatively, it should be appreciated that moves to some blocks may impact timing of other connections not directly made between blocks that have moved; accordingly, it may be desirable for the timing analyzer 244 to perform a complete analysis of the timing information after a change in layout has been detected.

The timing analyzer 244 updates the timing information and timing path slack values computed for the analyzed connections and then informs the visualization module 248 of the changes. The visualization module 248 of those changes, thereby allowing the visualization module 248 to update the presentation of flylines and information associated therewith (step 612). It may be that a depicted flyline now represents a different block-to-block connection (e.g., a connection between different pins of a pair of blocks) because the block movement resulted in a different connection becoming the constraining connection. However, since a flyline is used to depict the connection information, the flyline may be adjusted by simply changing the information depicted in connection therewith.

Finally, the visualization module 248 may highlight flylines or blocks with timing changes that exceed a predetermined threshold or are the newest constraining connections (step 616). In other words, a user is allowed to visualize, in real-time or near-real-time, whether changes to a layout have a positive or negative impact on timing of the layout.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method for visualizing timing margin of an Integrated Circuit design, comprising:
analyzing timing path slack for block-to-block connections in the Integrated Circuit design;
based on the analysis, determining a timing path slack value for each of the block-to-block connections;
associating the timing path slack value with each block in the block-to-block connection; and
presenting the timing path slack value along with at least one of: (i) a presentation of the block-to-block connection and (ii) an identifier of each block in the block-to-block connection.

2. The method of claim 1, wherein the timing path slack value is presented along with the presentation of the block-to-block connection.

3. The method of claim 2, wherein a color is assigned to the block-to-block connection based on the timing path slack value.

4. The method of claim 3, wherein a plurality of different slack tiers are defined and each of the plurality of slack tiers have different colors associated therewith and wherein the color assigned to the block-to-block connection is based on which of the plurality of slack tiers the timing path slack value belongs to.

5. The method of claim 1, wherein the timing path slack value corresponds to a worst timing path slack between blocks in the block-to-block connection.

6. The method of claim 1, wherein the timing path slack value corresponds to an average timing path slack between blocks in the block-to-block connection.

7. The method of claim 1, wherein the timing path slack value corresponds to a maximum timing slack value.

8. The method of claim 1, wherein the presentation of the block-to-block connection comprises a flyline and wherein the flyline is configured to be queried so as to portray the timing path slack value associated therewith and a pin in the block that carries the block-to-block connection.

9. The method of claim 1, wherein the block-to-block connections corresponds to connections between at least one of top-level blocks and top-level registers in the Integrated Circuit design.

10. A non-transitory computer-readable medium comprising processor-executable instructions that, when executed by a processor enable visualization of timing margin of an Integrated Circuit design, the instructions comprising:
instructions configured to analyze timing slack for each block-to-block connection in the Integrated Circuit design;
instructions configured to determine a timing path slack value for each block-to-block connection based on the analysis thereof; and
instructions configured to render a presentation of the determined timing path slack value in association with a presentation of the block-to-block connection in a rendering of the Integrated Circuit design.

11. The computer-readable medium of claim 10, wherein a color is assigned to each of the block-to-block connections based on the timing slack value associated therewith.

12. The computer-readable medium of claim 10, wherein the timing path slack value corresponds to at least one of: (i) a worst timing path slack between blocks in the block-to-block connection; (ii) an average timing path slack between blocks in the block-to-block connection; and (iii) a maximum timing margin.

13. The computer-readable medium of claim 10, wherein the presentation of the block-to-block connection comprises a flyline that connects the blocks in the block-to-block connection.

14. The computer-readable medium of claim 13, wherein the flyline is configured to be queried so as to portray the timing path slack value associated therewith and a pin in the block that carries the block-to-block connection.

15. The computer-readable medium of claim 10, wherein the timing path slack value is adjusted to accommodate multiple clock domains between the blocks in the block-to-block connection.

16. The computer-readable medium of claim 10, further comprising instructions configured to filter a display of the block-to-block connections along with their associated timing path slack value to only those block-to-block connections that have a timing path slack value that is less than a threshold slack value.

17. A system that enables visualization of timing margin of an Integrated Circuit, the system comprising:
a microprocessor configured to execute computer-readable instructions; and
computer memory having instructions stored thereon that enable the microprocessor to:
analyze timing slack for each block-to-block connection in the Integrated Circuit design;
determine a timing path slack value for each block-to-block connection based on the analysis thereof; and
prepare a presentation of the determined timing path slack value along with a presentation of the block-to-block connection via a Graphical User Interface (GUI).

18. The system of claim 17, wherein the timing path slack value corresponds to at least one of: (i) a worst timing path slack between blocks in the block-to-block connection; (ii) an average timing path slack between blocks in the block-to-block connection; and (iii) a maximum timing margin.

19. The system of claim 17, wherein the presentation of the block-to-block connection comprises a flyline that connects the blocks in the block-to-block connection and wherein the flyline is configured to be queried so as to portray the timing path slack value associated therewith and a pin in the block that carries the block-to-block connection.

20. The system of claim 17, wherein the instructions further enable the microprocessor to filter a display of the block-to-block connections along with their associated timing path slack value to only those block-to-block connections that have a timing path slack value that is less than a threshold slack value.
